(19) United States
(12) Patent Application Publication
(10) Pub. No.: US 2026/0141461 A1
(43) Pub. Date: May 21, 2026

(54) CLINICAL AI REIMBURSEMENT AND ECONOMIC IMPACT GOVERNANCE SYSTEM

(71) Applicant: George William Bickerstaff, III, Greenwich, CT (US)

(72) Inventor: George William Bickerstaff, III, Greenwich, CT (US)

(21) Appl. No.: 19/445,485

(22) Filed: Jan. 10, 2026

(51) Int. Cl. G06Q 40/12

(52) U.S. Cl. CPC G06Q 40/124

(57) ABSTRACT

A clinical AI reimbursement and economic impact governance system captures AI-assisted workflow events and computes auditable economic metrics aligned with healthcare reimbursement frameworks. The system generates value evidence packages and financial records while preserving clinician authority and regulatory compliance.

### TECHNICAL FIELD

The present invention relates to healthcare financial and operational governance systems and, more particularly, to computer-implemented systems and methods for measuring, attributing, and governing reimbursement and economic impact associated with artificial intelligence-assisted clinical workflows.

### BACKGROUND

Artificial intelligence systems are increasingly integrated into clinical workflows to support detection, prioritization, and care coordination across healthcare institutions.

Despite operational adoption, healthcare reimbursement frameworks remain largely disconnected from AI-enabled workflow impact, including changes in length of stay, resource utilization, and clinical throughput.

Existing reimbursement analytics systems rely heavily on retrospective manual analysis and lack technical linkage between AI workflow usage and financial outcomes.

This disconnect creates adoption barriers, limits evidence-based reimbursement discussions, and increases financial risk for institutions deploying clinical AI systems.

Accordingly, there exists a need for a technical governance system that attributes, measures, and audits reimbursement-relevant economic impact of AI-assisted clinical workflows without autonomously diagnosing conditions or directing treatment actions.

### SUMMARY OF THE INVENTION

The invention provides a computer-implemented clinical AI reimbursement and economic impact governance system that captures workflow events associated with AI-assisted care delivery.

The system applies attribution windows, reimbursement mapping rules, and economic computation logic aligned with healthcare reimbursement frameworks.

The system generates auditable economic impact metrics and value evidence packages while preserving clinician authority and avoiding autonomous medical decision-making.

All attribution assumptions, computations, and outputs are recorded as immutable audit artifacts suitable for financial governance and regulatory review.

### DEFINITIONS (ALPHABETICAL ORDER)

Attribution Window refers to a defined temporal interval during which economic effects are associated with one or more workflow events.
Clinical Workflow Event refers to a time-stamped occurrence within a governed clinical workflow associated with AI assistance.
Diagnosis-Related Group refers to a reimbursement classification used to determine hospital payment based on clinical and operational characteristics.
Economic Impact Metric refers to a quantified measure of cost, revenue, or resource utilization change.
Length of Stay Adjustment refers to a calculated difference between expected and observed hospitalization duration.
Reimbursement Mapping Rule refers to a rule linking workflow events to reimbursement frameworks.
Resource Utilization Metric refers to a quantified measure of consumed clinical or operational resources.
Revenue Attribution Record refers to an auditable record linking workflow events to financial outcomes.
Value Evidence Package refers to a structured dataset supporting reimbursement, payer, or financial governance discussions.
Workflow Impact Engine refers to a software component that computes economic metrics from workflow data.

### BRIEF DESCRIPTION OF THE DRAWINGS

FIG. 1 illustrates a clinical AI reimbursement governance system architecture.

FIG. 2 illustrates workflow event capture and attribution windows.

FIG. 3 illustrates reimbursement mapping and economic computation.

FIG. 4 illustrates reporting and value evidence packaging.

FIG. 5 illustrates audit logging and financial governance.

### DETAILED DESCRIPTION

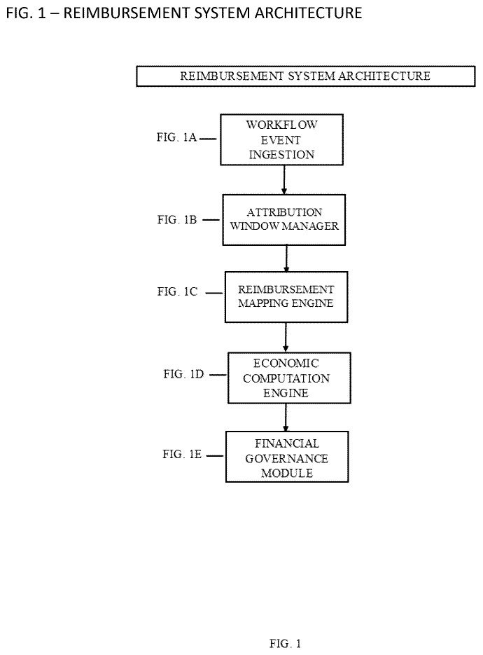

### FIG. 1—Reimbursement System Architecture

FIG. 1 illustrates a clinical AI reimbursement governance system comprising workflow event ingestion, attribution logic, reimbursement mapping, economic computation, and audit components. The system integrates with clinical workflow infrastructure without altering clinical decision authority. Deployment may occur within hospital environments or secure analytics platforms.

FIG. 1A—WORKFLOW EVENT INGESTION. FIG. 1A depicts ingestion of AI-associated workflow events with timestamps and contextual identifiers. Events are captured passively. Ingestion does not modify care delivery.

FIG. 1B—ATTRIBUTION WINDOW MANAGER. FIG. 1B illustrates definition of attribution windows for economic analysis. Windows bound the scope of impact measurement. Configuration is policy-driven.

FIG. 1C—REIMBURSEMENT MAPPING ENGINE. FIG. 1C depicts mapping of workflow events to reimbursement frameworks. Mapping rules align with payer structures. Mapping is auditable.

FIG. 1D—ECONOMIC COMPUTATION ENGINE. FIG. 1D illustrates computation of economic impact metrics. Computation is deterministic and reproducible. Results are stored.

FIG. 1E—FINANCIAL GOVERNANCE MODULE. FIG. 1E depicts governance and audit of economic computations. Records are immutable and time-stamped. Oversight is enforced.

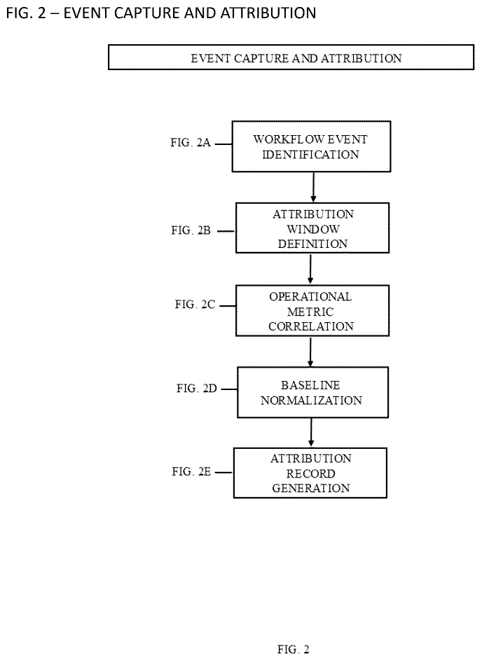

### FIG. 2—Event Capture and Attribution

FIG. 2 illustrates capture and attribution of workflow events associated with AI-assisted care. Events are correlated with operational metrics. Attribution supports financial analysis.

FIG. 2A—WORKFLOW EVENT IDENTIFICATION. FIG. 2A depicts identification of triggering workflow events. Events may include alerts or escalations. Identification does not imply causation.

FIG. 2B—ATTRIBUTION WINDOW DEFINITION. FIG. 2B illustrates assignment of attribution windows. Windows define temporal boundaries. Boundaries are configurable.

FIG. 2C—OPERATIONAL METRIC CORRELATION. FIG. 2C depicts correlation of events with operational metrics. Metrics include utilization and throughput. Correlation is logged.

FIG. 2D—BASELINE NORMALIZATION. FIG. 2D illustrates normalization against baseline expectations. Baselines derive from historical data. Normalization supports comparison.

FIG. 2E—ATTRIBUTION RECORD GENERATION. FIG. 2E depicts generation of revenue attribution records. Records link events to metrics. Records are versioned.

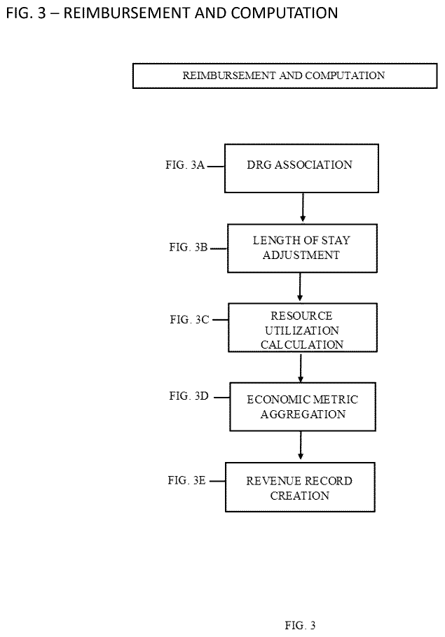

### FIG. 3—Reimbursement and Computation

FIG. 3 illustrates reimbursement mapping and economic computation. Mapping supports financial analysis. Billing processes remain unchanged.

FIG. 3A—DRG ASSOCIATION. FIG. 3A depicts association with diagnosis-related group categories. Association uses predefined rules. Rules are configurable.

FIG. 3B—LENGTH OF STAY ADJUSTMENT. FIG. 3B illustrates computation of length-of-stay adjustments. Adjustments compare expected and observed durations. Results are auditable.

FIG. 3C—RESOURCE UTILIZATION CALCULATION. FIG. 3C depicts calculation of resource utilization differences. Differences include imaging and ICU usage. Calculations are logged.

FIG. 3D—ECONOMIC METRIC AGGREGATION. FIG. 3D illustrates aggregation of economic impact metrics. Aggregation supports reporting. Traceability is preserved.

FIG. 3E—REVENUE RECORD CREATION. FIG. 3E depicts creation of revenue attribution records. Records link workflows to financial outcomes. Records are immutable.

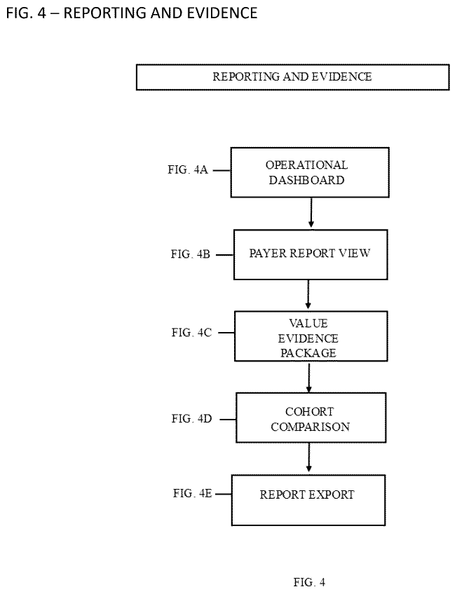

### FIG. 4—Reporting and Evidence

FIG. 4 illustrates reporting and value evidence packaging. Reports support internal and external stakeholders. Reporting does not influence care.

FIG. 4A—OPERATIONAL DASHBOARD. FIG. 4A depicts hospital-facing dashboards. Dashboards summarize metrics. Displays are read-only.

FIG. 4B—PAYER REPORT VIEW. FIG. 4B illustrates payer-aligned reporting views. Views align with reimbursement frameworks. Alignment supports discussion.

FIG. 4C—VALUE EVIDENCE PACKAGE. FIG. 4C depicts generation of value evidence packages. Packages include metrics and assumptions. Packages are versioned.

FIG. 4D—COHORT COMPARISON. FIG. 4D illustrates comparative cohort analysis. Analysis supports benchmarking. Comparisons are contextualized.

FIG. 4E—REPORT EXPORT. FIG. 4E depicts export of reports and evidence. Export formats are standardized. Exports support negotiation.

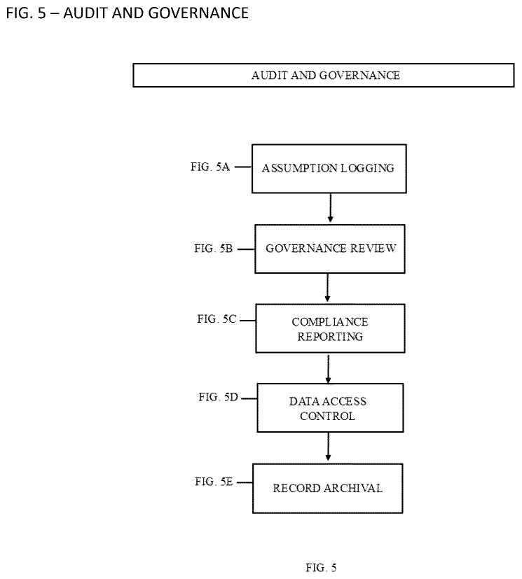

### FIG. 5—Audit and Governance

FIG. 5 illustrates audit logging and financial governance. Logs capture assumptions and computations. Oversight is enforced.

FIG. 5A—ASSUMPTION LOGGING. FIG. 5A depicts logging of attribution assumptions. Assumptions are time-stamped. Context is preserved.

FIG. 5B—GOVERNANCE REVIEW. FIG. 5B illustrates governance review workflows. Reviews require authorization. Decisions are recorded.

FIG. 5C—COMPLIANCE REPORTING. FIG. 5C depicts financial compliance reporting. Reports support audits. Reports are immutable.

FIG. 5D—DATA ACCESS CONTROL. FIG. 5D illustrates role-based access control. Access events are logged. Controls are enforced.

FIG. 5E—RECORD ARCHIVAL. FIG. 5E depicts archival of financial records. Records are retained per policy. Long-term review is supported.

### ILLUSTRATIVE OPERATIONAL EXAMPLE

In one example, an AI-assisted stroke workflow reduces average length of stay across a patient cohort. Workflow events are captured and correlated with hospitalization duration.

The system computes a length-of-stay adjustment and maps the adjustment to diagnosis-related group reimbursement expectations. A revenue attribution record is generated.

A value evidence package is produced for payer discussion documenting assumptions and metrics. The system does not autonomously diagnose conditions or prescribe treatment.

1. A computer-implemented system comprising one or more processors and memory storing instructions that cause the system to capture AI-assisted workflow events, apply attribution windows, map events to reimbursement frameworks, compute economic impact metrics, and generate auditable revenue attribution records, wherein the system does not autonomously diagnose a medical condition or prescribe treatment.

2. A method comprising capturing AI-assisted workflow events, defining attribution windows, computing economic impact metrics aligned with reimbursement frameworks, and generating auditable financial records.

3. A non-transitory computer-readable medium storing instructions that cause one or more processors to perform the method of claim 2.

4. The system of claim 1, wherein economic impact metrics include length-of-stay adjustments.

5. The system of claim 1, wherein reimbursement mapping includes diagnosis-related groups.

6. The system of claim 1, wherein resource utilization metrics are computed.

7. The system of claim 1, wherein value evidence packages are generated.

8. The system of claim 1, wherein financial records are immutable.

9. The method of claim 2, wherein baseline normalization is applied.

10. The system of claim 1, wherein payer-aligned reporting views are produced.
